(19) United States
(12) Patent Application Publication
(10) Pub. No.: US 2025/0297633 A1
(43) Pub. Date: Sep. 25, 2025

(54) FLASHING-LESS ATTACHMENT APPARATUS AND METHODS THEREFOR

(71) Applicant: Unirac, Inc., Albuquerque, NM (US)

(72) Inventor: Todd Ganshaw, Albuquerque, NM (US)

(21) Appl. No.: 19/086,035

(22) Filed: Mar. 20, 2025

Related U.S. Application Data
(60) Provisional application No. 63/568,366, filed on Mar. 21, 2024.

(51) Int. Cl. F16B 33/00; H02S 20/23

(52) U.S. Cl. CPC F16B 33/004; H02S 20/23

(57) ABSTRACT

An apparatus including a container having a top end and a bottom end. The container may include a casing. The casing may include a reservoir extending from the top end of the container to a bottom end of the reservoir in a direction, and a conduit extending from a bottom end of the reservoir to the bottom end of the container in the direction. The apparatus may also include a plunger disposed within the reservoir, a sealant, and a fastener.

### CROSS-REFERENCE TO RELATED APPLICATION

This application claims benefit of U.S. Provisional Application No. 63/568,366 filed Mar. 21, 2024 and titled “Flashing-less Attachment Apparatus and Methods Therefor,” which is incorporated herein by reference in its entirety.

### BACKGROUND

As the solar energy industry continues to grow, the equipment to mount photovoltaic (PV) modules on different types of structures and/or locations continues to adapt and improve. Conventional PV mounting assemblies are frequently designed to be installed with a threaded fastener penetrating the roof and a sealant to prevent water penetration into the roof. Conventional mounting assemblies may require using excessive amounts of sealant and/or specialized tools. Accordingly, conventional mounting assemblies may create excessive waste and require additional tools and/or materials to be carried and handled by workers on a rooftop, which increases the potential for accidents in an already hazardous work environment. Despite the numerous existing systems for mounting PV modules, there is room for improvement.

### BRIEF DESCRIPTION OF THE DRAWINGS

FIG. 1 illustrates a cross-sectional view of an attachment system that includes a roof mount with a flashing-less attachment apparatus prepared for installation on a roof, according to an embodiment of this disclosure.

FIG. 2 illustrates a detailed view of the cross-section of FIG. 1, according to an embodiment of this disclosure.

FIG. 3 illustrates a cross-sectional view of a two-piece flashing-less attachment apparatus, according to an embodiment of this disclosure.

FIG. 4 illustrates a cross-sectional view of a one-piece flashing-less attachment apparatus, according to an embodiment of this disclosure.

FIG. 5 illustrates a cross-sectional view of a one-piece flashing-less attachment apparatus, according to an embodiment of this disclosure.

FIG. 6 illustrates a partial cross-sectional view of a one-piece flashing-less attachment apparatus, prior to installation on a roof, according to an embodiment of this disclosure.

FIG. 7 illustrates a partial cross-sectional view of the one-piece flashing-less attachment apparatus of FIG. 6 after installation on a roof, according to an embodiment of this disclosure.

FIG. 8 illustrates an isometric view of a two-piece flashing-less attachment apparatus, according to an embodiment of this disclosure.

FIG. 9 illustrates a cross-sectional view of a two-piece flashing-less attachment apparatus and two fasteners, according to an embodiment of this disclosure.

FIG. 10 illustrates a cross-sectional view of the two-piece flashing-less attachment apparatus of FIG. 9 fastened to a roof, according to an embodiment of this disclosure.

FIG. 11 illustrates a cross-sectional view of an attachment system that includes a roof mount with the flashing-less attachment apparatus of FIG. 1 prepared for installation on a roof, according to an embodiment of this disclosure.

### DETAILED DESCRIPTION

### Overview

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

The following solutions utilize a flashing-less type of attachment that is prepackaged with a sealant. In this manner, the sealant may be pre-installed or pre-applied to the attachment. Moreover, some of the sealants described herein may have a self-contained adhesive packet or a fastener with the sealant disposed around threads of the fastener. In doing so, when the fastener is installed into a surface, such as a roof, the sealant forms a seal around penetrations into the surface.

In an embodiment, the sealant may include an adhesive sealant or a flowable sealant (e.g., silicone, butyl, polyurethane, acrylic, latex, etc.). The sealant may be applied to the fasteners and/or an attachment configured to receive the fasteners using any suitable methods. For example, the sealant may be applied as strips of adhesive. Alternatively, the sealant may be disposed along the fastener using a caulk gun. The sealant may also be injected into the attachment and/or along a length of the fastener.

In an embodiment, an attachment may include a rigid body that forms a cavity. The cavity may be disposed on an underside of the body, which when disposed on the roof, is oriented towards the roof. In other words, the cavity may be open to the roof.

In an embodiment, sealant that is pre-disposed in the cavity may seal against the roof. For example, the sealant may be compressed against the surface through various mechanisms. In an embodiment, the sealant may be compressed via driving the attachment to the roof, driving fasteners into the attachment, driving fasteners into a piston, plunger, diaphragm, etc. In an embodiment, a piston, plunger, diaphragm, or similar compression device may force the sealant to flow against and contact the surface to at least partially or fill the cavity and roof penetrations.

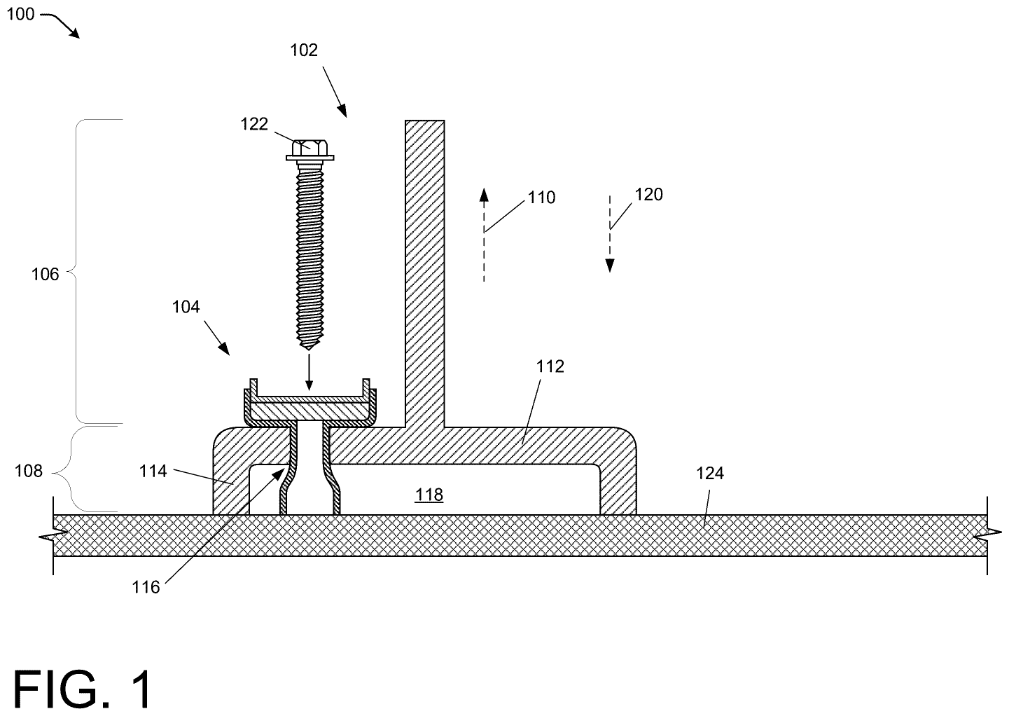

Specifically, FIG. 1 illustrates a cross-sectional view of an attachment system 100 that includes a roof mount 102 with a flashing-less attachment apparatus 104 prepared for installation on a roof 124. In an embodiment, the roof mount 102 may be made of a rigid material (e.g., metal, plastic, polycarbonate, etc.). The roof mount 102 may include an upper portion 106 (e.g., mount portion, protrusion, etc.) and a lower portion 108 (e.g., base, etc.).

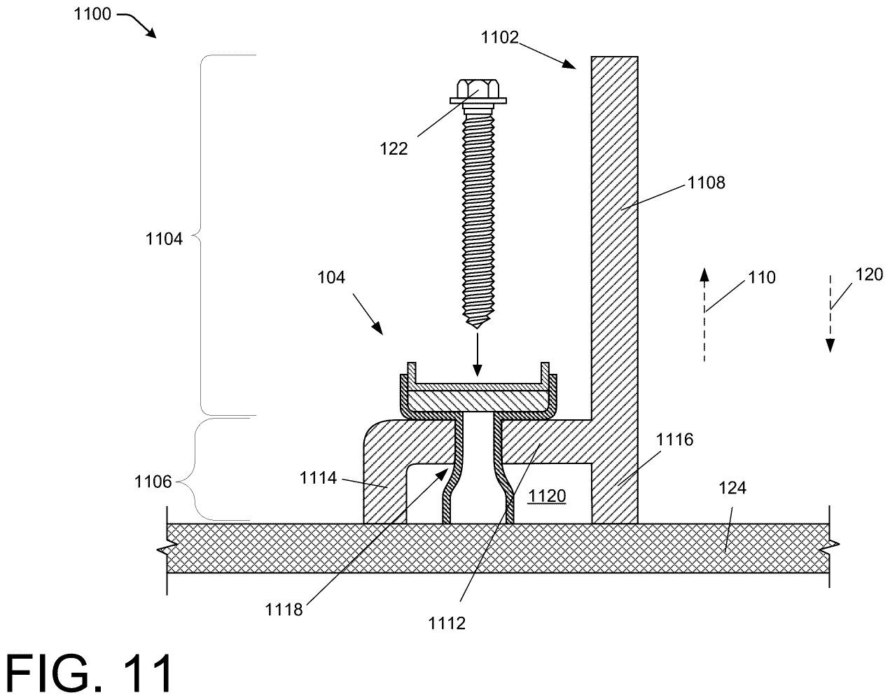

In an embodiment, the roof mount 102 may resemble a “T” shape, whereby the upper portion 106 may extend from the lower portion 108 at a centerline axis. Alternatively, other styles or shaped roof mounts may be used. For example, the roof mount 102 may include an “L” shape (see FIG. 11), a “Z” shape (not shown), etc.).

In an embodiment, the upper portion 106 may be configured to receive a mounting device (e.g., rail clamp, etc.). The upper portion 106 may extend from the lower portion 108 in a first direction 110. In an embodiment, the lower portion 108 may include a baseplate 112, a sidewall 114, and an aperture 116. In an embodiment, the aperture 116 may be circular. Alternatively, the aperture 116 may be elongated (e.g., elliptical).

In an embodiment, the lower portion 108 may include a cavity 118 defined by the baseplate 112 and the sidewall 114. The cavity 118 may open in a second direction 120. In an embodiment, the cavity 118 may open to a roof 124.

In an embodiment, the flashing-less attachment apparatus 104 may include a fastener 122. In an embodiment, the flashing-less attachment apparatus 104 and the fastener 122 may be incorporated into a single device. The fastener 122 may be sized to have a sufficient length so as to penetrate the roof 124 at a first end and engage with the flashing-less attachment apparatus 104 at a second end.

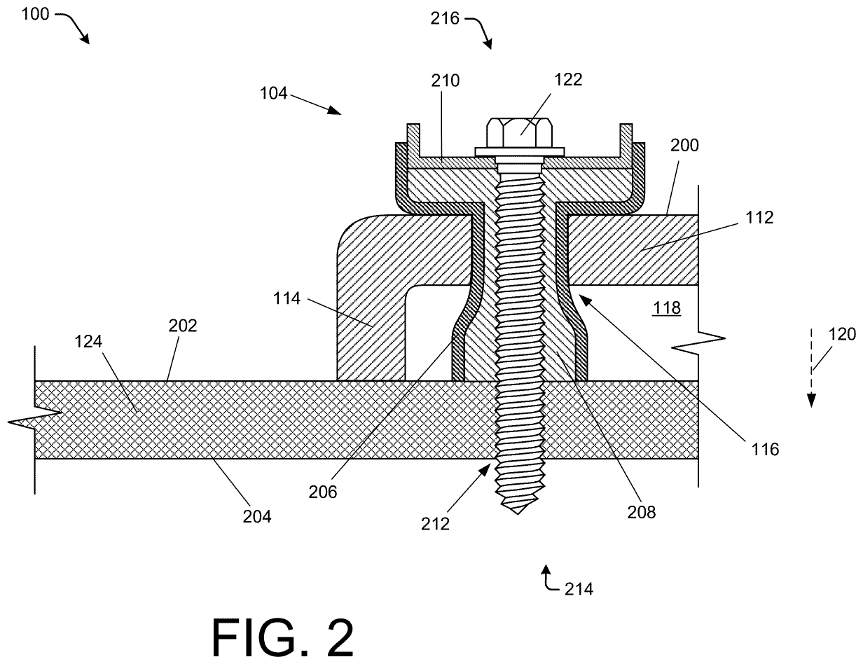

FIG. 2 illustrates a detailed cross-sectional view of a portion of the roof mount 102 of FIG. 1, with the flashing-less attachment apparatus 104 fastened to the roof 124. The baseplate 112 may include a top surface 200 (e.g., first surface, upper surface, etc.). The roof 124 may include a top surface 202 (e.g., first surface, upper surface, etc.) and a bottom surface 204 opposite the top surface 202. In an embodiment, the flashing-less attachment apparatus 104 may include a casing 206, a sealant 208, and a plunger 210.

In an embodiment, when the flashing-less attachment apparatus 104 is attached to the roof mount 102, the flashing-less attachment apparatus 104 may partially abut against the top surface 200 of the baseplate 112. When the roof mount 102 has been fastened to the roof 124, the fastener 122 may be disposed through the roof 124 in a borehole 212 created by the fastener 122.

As the fastener 122 travels in the second direction 120 into the roof 124, a second end 216 (e.g., head, top, etc.) of the fastener 122 may engage with the plunger 210. This causes the plunger 210 to travel in the second direction 120. As the plunger 210 travels in the second direction 120, the plunger 210 may force the sealant 208 through the casing 206 in the second direction 120. Consequently, the sealant 208 may be advanced towards the borehole 212. In an embodiment, the plunger 210 may force the sealant 208 into the borehole 212. In an embodiment, the sealant 208 may be forced through the borehole 212 such that the sealant 208 extends past the bottom surface 204 of the roof 124. Regardless, the sealant 208 may be disposed around the borehole 212. In an embodiment, the casing 206 may restrict flow of the sealant 208 to within the casing 206 and prevent flow of the sealant 208 into the cavity 118. In this manner, the casing 206 may localize a seal around the fastener 122 to prevent an ingress of liquid into the roof 124, as compared to filing an entirety of the cavity 118 to seal penetrations into the roof 124.

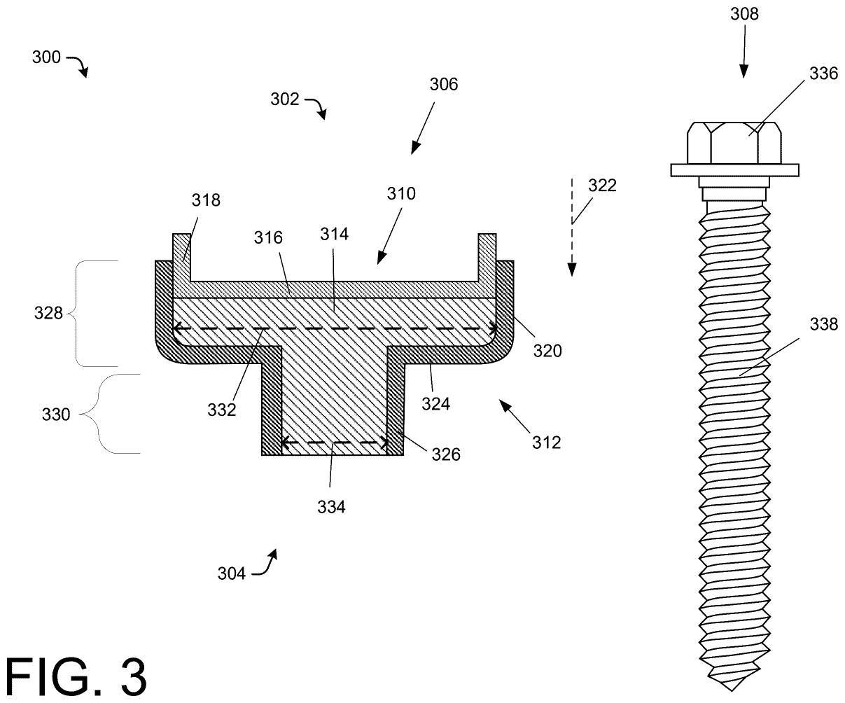

FIG. 3 illustrates a cross-sectional view of a two-piece flashing-less attachment apparatus 300 (“apparatus 300”) having a top end 302 (e.g., first end, etc.) and a bottom end 304 (e.g., second end, etc.).

In an embodiment, the apparatus 300 may include a container 306 and a fastener 308. In an embodiment, the container 306 may include a plunger 310, a casing 312, and a sealant 314. The plunger 310 may include a base 316 and a sidewall 318. The casing 312 may include a first sidewall 320 (e.g., upper sidewall, top sidewall, reservoir wall, etc.) extending in a direction 322 (e.g., downward, etc.), a shoulder 324 extending from the first sidewall 320 toward a vertical centerline axis of the container 306, and a second sidewall 326 (e.g., lower sidewall, bottom sidewall, conduit wall, etc.) extending from the shoulder 324 in the direction 322.

In an embodiment, the container 306 may include a reservoir 328 (e.g., upper section, top section, etc.) and a conduit 330 (e.g., lower section, bottom section, etc.). The reservoir 328 may be defined by the plunger 310, the first sidewall 320, and the shoulder 324. In an embodiment, the reservoir 328 may contain the sealant 314. In an embodiment, the reservoir 328 may have a first width 332 (e.g., reservoir width, etc.).

The conduit 330 may be defined by the second sidewall 326. In an embodiment, the conduit 330 may contain the sealant 314. In an embodiment, the conduit 330 may have a second width 334 (e.g., conduit width, etc.) that is less than the first width 332. The transition of the first width 332 of the reservoir 328 to the second width 334 of the conduit 330 (e.g., the narrowing of the casing 312 from the top end 302 of the apparatus 300 to the bottom end 304 of the apparatus 300) promotes the flow of the sealant 314 from the reservoir 328 to the conduit 330 as the plunger 310 travels in the direction 322.

In an embodiment, the conduit 330 may be configured to engage with an aperture (not shown) of a roof mount (e.g., roof mount 102 of FIG. 1, or any mount configured to receive sealant via an aperture, etc.).

In an embodiment, the fastener 308 may include a head 336 and a pointed shaft 338. The pointed shaft 338 of the fastener 308 may be configured to penetrate the base 316 of the plunger 310. The head 336 of the fastener 308 may be configured to engage with the base 316 of the plunger 310 such that as the fastener 308 travels in the direction 322, the head 336 forces the plunger 310 to travel in the direction 322. As the plunger 310 travels in the direction 322, the portion of the sealant 314 in the reservoir 328 is forced into the conduit 330.

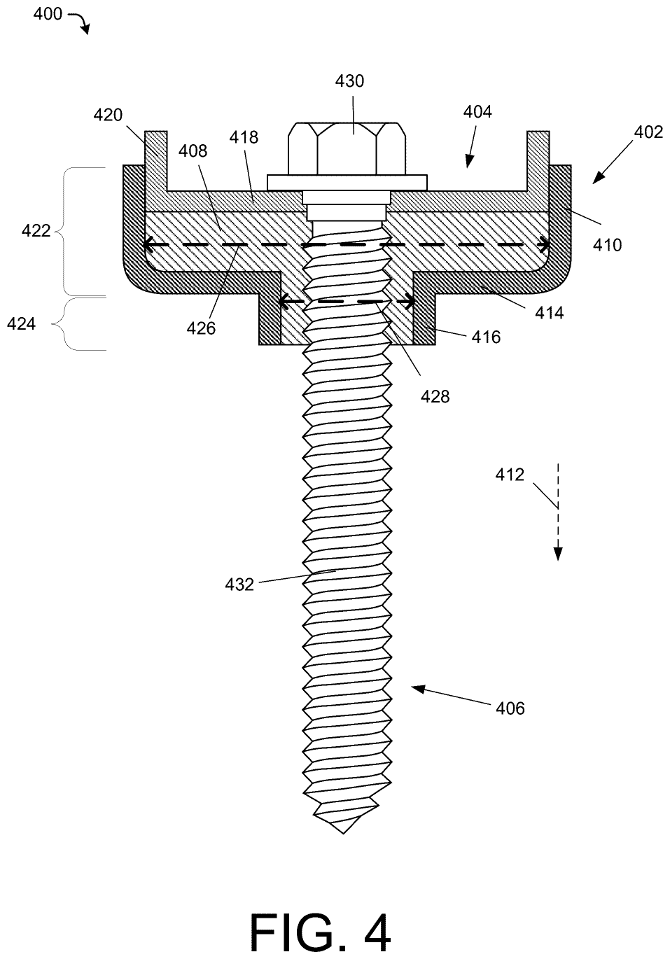

FIG. 4 illustrates a cross-sectional view of a one-piece flashing-less attachment apparatus 400 (“apparatus 400”). The apparatus 400 may be circular. In an embodiment, the apparatus 400 may include a casing 402, a plunger 404, a fastener 406, and a sealant 408. In an embodiment, the casing 402 may include a first sidewall 410 (e.g., upper sidewall, top sidewall, reservoir wall, etc.) extending in a direction 412. The casing 402 may include a shoulder 414 extending from the first sidewall 410 toward a vertical centerline axis of the apparatus 400. The first sidewall 410 may circumferentially surround the shoulder 414. The casing 402 may include a second sidewall 416 (e.g., lower sidewall, bottom sidewall, conduit wall, etc.) extending from the shoulder 414 in the direction 412.

In an embodiment, the plunger 404 may include a base 418 and a sidewall 420. The sidewall 420 may circumferentially surround the base 418. The plunger 404 may be disposed within the first sidewall 410 of the casing 402 such that the sidewall 420 of the plunger 404 may engage with the first sidewall 410 of the casing 402.

In an embodiment, the apparatus 400 may include a sealant reservoir 422 (e.g., upper section, top section, etc.) and a sealant conduit 424 (e.g., lower section, bottom section, etc.) with the fastener 406 disposed through the sealant reservoir 422 and the sealant conduit 424 in the direction 412. The sealant reservoir 422 may be defined by the plunger 404, the first sidewall 410, the shoulder 414, and a portion of the sealant 408. In an embodiment, the sealant reservoir 422 may have a first width 426 (e.g., reservoir width, etc.).

The sealant conduit 424 may be defined by the second sidewall 416. In an embodiment, the sealant conduit 424 may have a second width 428 (e.g., conduit width, etc.) that is less than the first width 426. In an embodiment, the sealant conduit 424 may be configured to engage with an aperture (not shown) of a roof mount (e.g., roof mount 102 of FIG. 1, or any mount configured to receive sealant via an aperture, etc.).

In an embodiment, the fastener 406 may include a head 430 and a pointed shaft 432. The pointed shaft 432 of the fastener 406 may be configured to penetrate the base 418 of the plunger 404. The head 430 of the fastener 406 may be configured to engage with the base 418 of the plunger 404 such that as the fastener 406 travels in the direction 412, the head 430 forces the plunger 404 to travel in the direction 412. As the plunger 404 travels in the direction 412, the portion of the sealant 408 in the sealant reservoir 422 is forced into the sealant conduit 424.

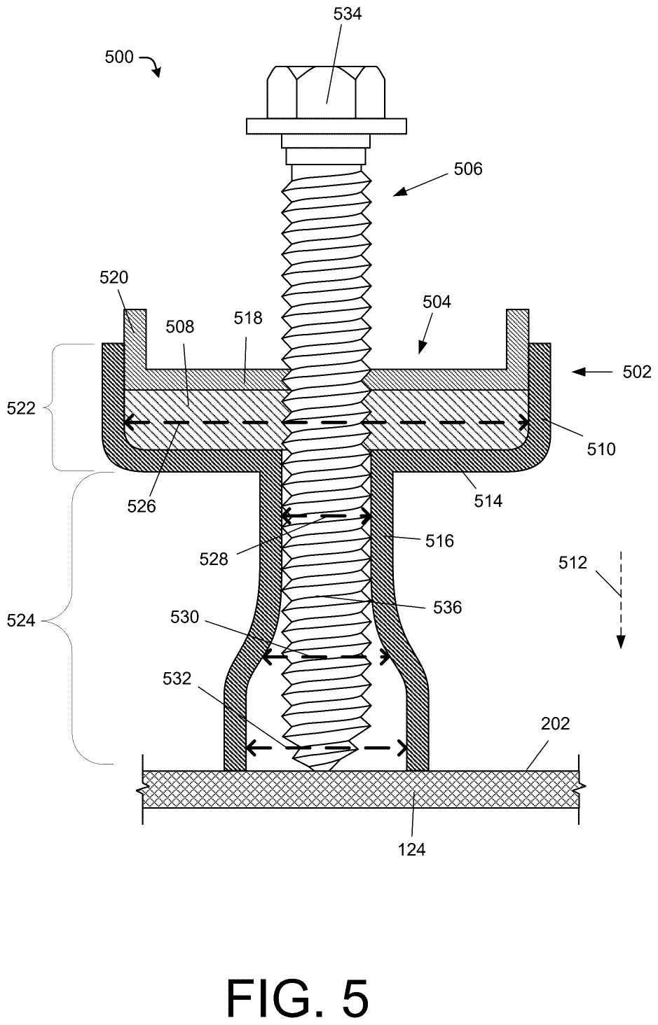

FIG. 5 illustrates a cross-sectional view of a one-piece flashing-less attachment apparatus 500 (“apparatus 500”). In an embodiment, the apparatus 500 may include a casing 502, a plunger 504, a fastener 506, and a sealant 508. In an embodiment, the casing 502 may include a first sidewall 510 (e.g., upper sidewall, top sidewall, reservoir wall, etc.) extending in a direction 512, a shoulder 514 extending from the first sidewall 510 toward a vertical centerline axis of the apparatus 500, and a second sidewall 516 (e.g., lower sidewall, bottom sidewall, conduit wall, etc.) extending from the shoulder 514 in the direction 512. In an embodiment, the second sidewall 516 may be configured to engage with the top surface 202 of the roof 124.

In an embodiment, the plunger 504 may include a base 518 and a sidewall 520. The plunger 504 may be disposed within the first sidewall 510 of the casing 502 such that the sidewall 520 of the plunger 504 may planarly engage with the first sidewall 510 of the casing 502.

In an embodiment, the apparatus 500 may include a sealant reservoir 522 (e.g., upper section, top section, etc.) and a conduit 524 (e.g., lower section, bottom section, etc.) with the fastener 506 disposed through the sealant reservoir 522 and the conduit 524 in the direction 512. The sealant reservoir 522 may be defined by the plunger 504, the first sidewall 510, and the shoulder 514. In an embodiment, the sealant reservoir 522 may contain the sealant 508. In an embodiment, the sealant reservoir 522 may have a width 526 (e.g., reservoir width, etc.).

The conduit 524 may be defined by the shoulder 514 and the second sidewall 516. The conduit 524 may contain the sealant 508. In an embodiment, a first portion of the conduit 524 may have an initial width 528 (e.g., first conduit width, upper conduit width, etc.) that is less than the width 526. In an embodiment, the conduit 524 may transition from the first portion having the initial width 528 to a second portion having an intermediate width 530 that is larger than the initial width 528. In an embodiment, the conduit 524 may transition from the second portion having the intermediate width 530 to a third portion having a final width 532 that is greater than the intermediate width 530. In an embodiment, the transition from the initial width 528 to the final width 532 in the sealant conduit may be a sloped, linearly, and/or gradually transition (e.g., the conduit 524 may be flared out from the first portion of the conduit to the third portion of the conduit 524).

In an embodiment, the conduit 524 may be configured to be disposed within an aperture (not shown) of a roof mount (e.g., roof mount 102 of FIG. 1, or any mount configured to receive sealant via an aperture, etc.) and engage with the top surface 202 of the roof 124.

In an embodiment, the fastener 506 may include a head 534 and a pointed shaft 536. The pointed shaft 536 of the fastener 506 may be configured to penetrate the base 518 of the plunger 504. The head 534 of the fastener 506 may be configured to engage with the base 518 of the plunger 504 such that as the fastener 506 travels in the direction 512, the head 534 forces the plunger 504 to travel in the direction 512. As the plunger 504 travels in the direction 512, the sealant 508 in the reservoir 522 is forced into the conduit 524.

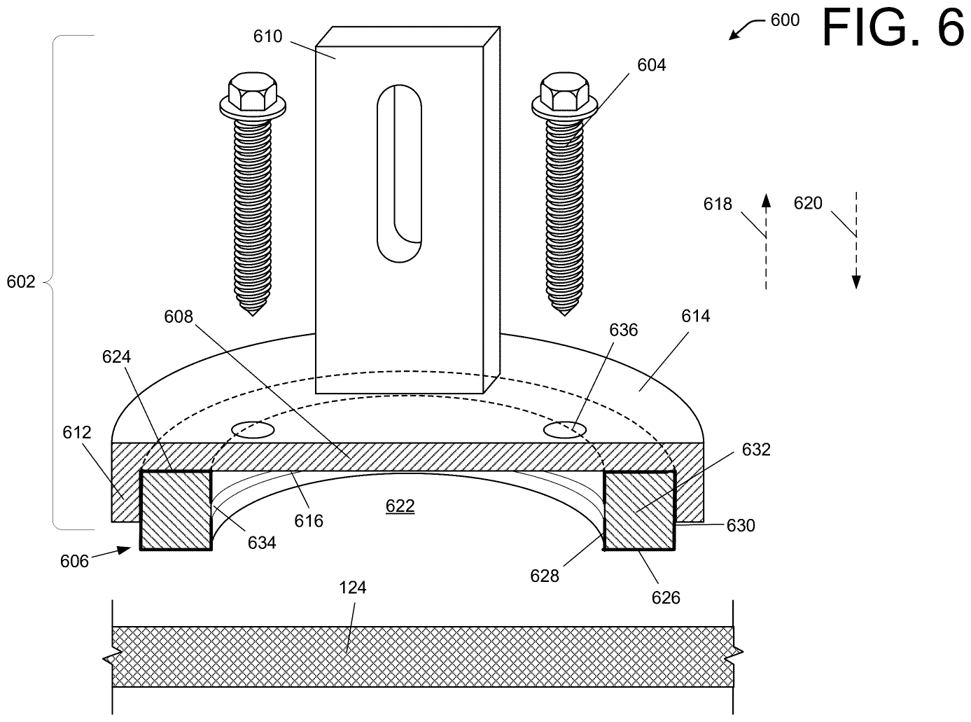

FIG. 6 illustrates a partial cross-sectional view of a one-piece flashing-less attachment apparatus 600 (“apparatus 600”) prior to installation. In an embodiment, the apparatus 600 may include a mount 602, a fastener 604, and a sealant packet 606 attached to the mount 602. In an embodiment, the mount 602 may be made of a rigid material (e.g., plastic, cast metal, composite, or any other suitable material).

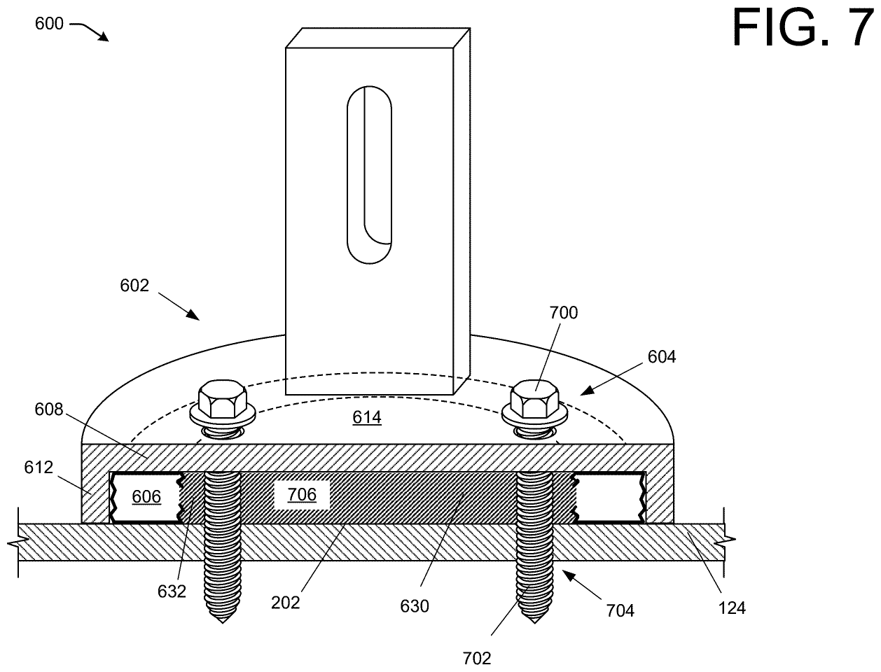

In an embodiment, the mount 602 may include a baseplate 608 (while depicted in FIGS. 6 and 7 as having a round shape, the baseplate 608 may be manufactured to have a different shape), a protrusion 610 (e.g., flange, vertical flange, etc.), and a sidewall 612. The baseplate 608 may have a first surface 614 (e.g., top surface, upper surface, etc.) and a second surface 616 (e.g., bottom surface, lower surface, etc.). The protrusion 610 may extend from the top surface 614 of the baseplate 608 in a direction 618 (e.g., upward direction, first direction, etc.). The sidewall 612 may extend from the second surface 616 of the baseplate 608 in a direction 620 (e.g., downward direction, second direction, etc.). In an embodiment, the mount 602 may include a cavity 622 defined by the baseplate 608 and the sidewall 612. The cavity 622 may open in the second direction 620.

In an embodiment, the sealant packet 606 may be partially disposed in the cavity 622. The sealant packet 606 may be collapsible (e.g., compressible, etc.) in the second direction 620. The sealant packet 606 may include a first wall 624 (e.g., top wall, upper wall, etc.), a second wall 626 (e.g., bottom wall, lower wall, etc.) opposite the first wall 624, a third wall 628 (e.g., inside wall, inner wall, etc.), a fourth wall 630 (e.g., outside wall, outer wall, etc.), and a sealant 632. In an embodiment, the top wall 624 of the sealant packet 606 may be attached to the bottom surface 616 of the baseplate 608 and extend adjacent to the sidewall 612 of the mount 602.

In an embodiment, the inside wall 628 of the sealant packet 606 may include a deformation 634 (e.g., indentation, thinned portion, microfracture, etc.). The deformation 634 may have less tensile strength relative to the top wall 624, the bottom wall 626, the inside wall 628 and the outside wall 630. For example, when the sealant packet 606 is compressed (by pressing the apparatus 600 against a roof 124, for example), the sealant 632 within the sealant packet 606 will cause the deformation 634 of the inside wall 628 to rupture, thus causing the sealant 632 to flow into the cavity 622.

In an embodiment, the baseplate 608 may include an aperture 636. In an embodiment, the baseplate 608 may include multiple apertures 636 disposed through the baseplate 608. The fastener 604 may be configured to be disposed through the aperture 638 and penetrate the roof 124. As the fastener 604 penetrates into the roof 124 in the second direction 620, the mount 602 may draw closer to the roof 124.

The bottom wall 626 of the sealant packet 606 may contact the roof 124. In an embodiment, the mount 602 may continue to be drawn towards the roof 124 in the second direction 620 after the bottom wall 626 of the sealant packet 606 contacts the roof 124. As the mount 602 continues to be drawn towards the roof 124 in the second direction 620, the sealant packet 606 may compress. The sealant packet 606 may compress until the deformation 634 of the inside wall 628 ruptures and forces the sealant 632 to flow into the cavity 622. In doing so, the sealant 632 seals around the penetrations into the roof 124.

FIG. 7 illustrates a partial cross-sectional view of the one-piece flashing-less attachment apparatus 600 of FIG. 6 after installation on a roof 124.

In an embodiment, the fastener 604 may include a head 700 and a pointed shaft 702. When the apparatus 600 is installed on a roof 124, the head 700 of the fastener 604 may be engaged with the top surface 614 of the baseplate 608 while the pointed shaft 702 extends through the roof 124 creating a borehole 704 through the roof 124. In an embodiment, the compression of the sealant packet 606 may cause a rupture of the sealant packet 606 and injection of the sealant 632 into a cavity 706 defined by the baseplate 608, the sidewall 612, and a surface 202 (e.g., top surface, upper surface, mounting surface, etc.) of the roof 124. In an embodiment, the sealant 632 may also flow into the borehole 704 and any other unobstructed penetrations (e.g., previous boreholes) in the portion of the roof 124 within the cavity 622.

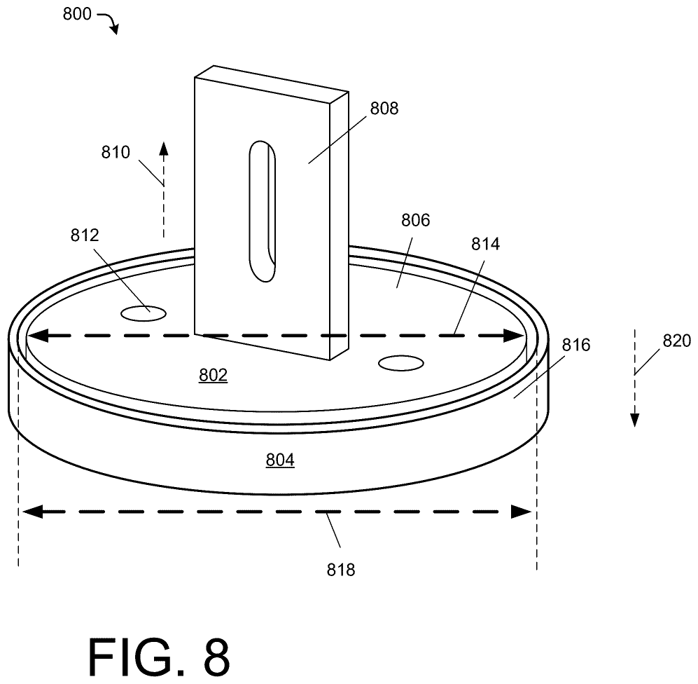

FIG. 8 illustrates a side and top view of a two-piece flashing-less attachment apparatus 800 (“apparatus 800”). In an embodiment, the apparatus 800 may include a piston 802 and a base 804. In an embodiment, the base 804 may be cylindrical. In an embodiment, the piston 802 may include a top surface 806, a flange 808 (e.g., vertical flange, protrusion, mounting flange, etc.) extending from the top surface 806 in a first direction 810, and an aperture 812 disposed through the piston 802. In an embodiment, the piston 802 may have a width 814 (e.g., first width, piston width, etc.).

In an embodiment, the mount base 804 may include a sidewall 816. The base 804 may have a width 818 (e.g., second width, mount base width, mount width, etc.) that is greater than the piston width 814. In an embodiment, the piston 802 may be disposed within the mount base 804 and configured to travel in a second direction 820 (e.g., downward, etc.) within the mount base 804.

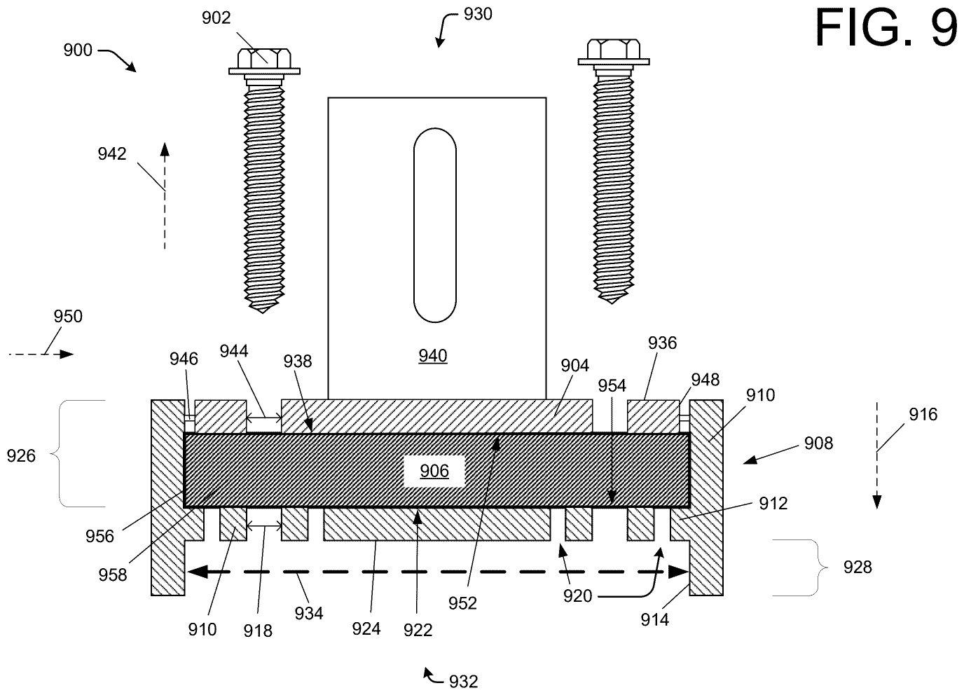

FIG. 9 illustrates a cross-sectional view of a two-piece flashing-less attachment apparatus 900 (“apparatus 900”) and two fasteners 902. In an embodiment, the apparatus 900 may include a piston 904, a sealant packet 906, and a base 908. The apparatus 900 may be made from any suitably rigid material (e.g., cast metal, forged metal, plastic, composite, etc.).

In an embodiment, the base 908 may include a sidewall 910 that extends to form a cylindrical shell. In an embodiment, the base 908 may include a shelf 912 (e.g., divider, partition) that extends from an inside surface 914 (e.g., first surface, inner surface, etc.) of the sidewall 910. The shelf 912 may extend circumferentially from the inside surface 914 of the sidewall 910 in a direction toward a vertical centerline axis of the base 908. In an embodiment, the shelf 912 may be solid with a uniform thickness throughout.

In an embodiment, the shelf 912 may include a plurality of apertures extending through the shelf 912 in a first direction 916 (e.g., downward, etc.). The plurality of apertures may include a fastener aperture 918 and a sealant flow aperture 920. In an embodiment, the shelf 912 may include multiple fastener apertures 918 and/or multiple sealant flow apertures 920. The fastener apertures 918 and/or multiple sealant flow apertures 920 may begin at a top surface 922 of the shelf 912 and extend through the shelf 912 to a bottom surface 924 of the shelf 912.

In an embodiment, the shelf 912 may divide the base 908 into an upper section 926 (e.g., first section, top section, etc.) and a lower section 928 (e.g., second section, bottom section, etc.). The shelf 912 may therefore be disposed between the upper section 926 and the lower section 928. However, through the fastener aperture 918 and the sealant flow aperture 920, the upper section 926 and the lower section 928 may be fluidly connected.

The upper section 926 may extend from a top end 930 of the base 908 to the top surface 922 of the shelf 912. The piston 904 and the sealant packet 906 may be disposed within the upper section 926. The lower section 928 may extend from the bottom surface 924 of the shelf 912 to a bottom end 932 of the base 908. The lower section 928 may include a cavity 934.

In an embodiment, the piston 904 may have a top surface 938 (e.g., first surface, etc.) and a bottom surface 938 (e.g., second surface, etc.). In an embodiment, a flange 940 may extend from the top surface 936 of the piston 904 in a second direction 942 (e.g., upward, etc.). In an embodiment, the flange 940 may be configured to receive a mountable device (e.g., a mounting rail, a solar module clamp, etc.). The piston 904 may include an aperture 944 disposed through the piston 904. The aperture 944 of the piston 904 may be aligned with the fastener aperture 918 of the shelf 912 such that the fastener 902 may penetrate the apparatus 900.

In an embodiment, the apparatus 900 may include one or more tabs 946 that extend from an outside surface 948 of the piston 904 to the inner surface 914 of the sidewall 910 in a third direction 950. When the tab 946 is attached to the piston 904 and the sidewall 910 of the base 908, the piston 904 may be frozen in place (e.g., the piston 904 may not be able to travel in the first direction 916 or the second direction 942).

In an embodiment, the sealant packet 906 may include a first wall 952 (e.g., a top wall, upper wall, etc.), a second wall 954 (e.g., a bottom wall, lower wall, etc.), and a third wall 956 (e.g., a side wall, lateral wall, etc.). The sealant packet 906 may be filled with a sealant 958. In an embodiment, the top wall 952 may be attached to the bottom surface 938 of the piston 904, the bottom wall 954 may be attached to the top surface of the shelf 912, and/or the lateral wall 956 may be attached to the inner surface 914 of the sidewall 910 of the base 908.

In an embodiment, the sealant packet 906 may have sufficient rigidity to prevent the piston 904 from being able to travel in the first direction 916 (e.g., the piston 904 may be frozen in place).

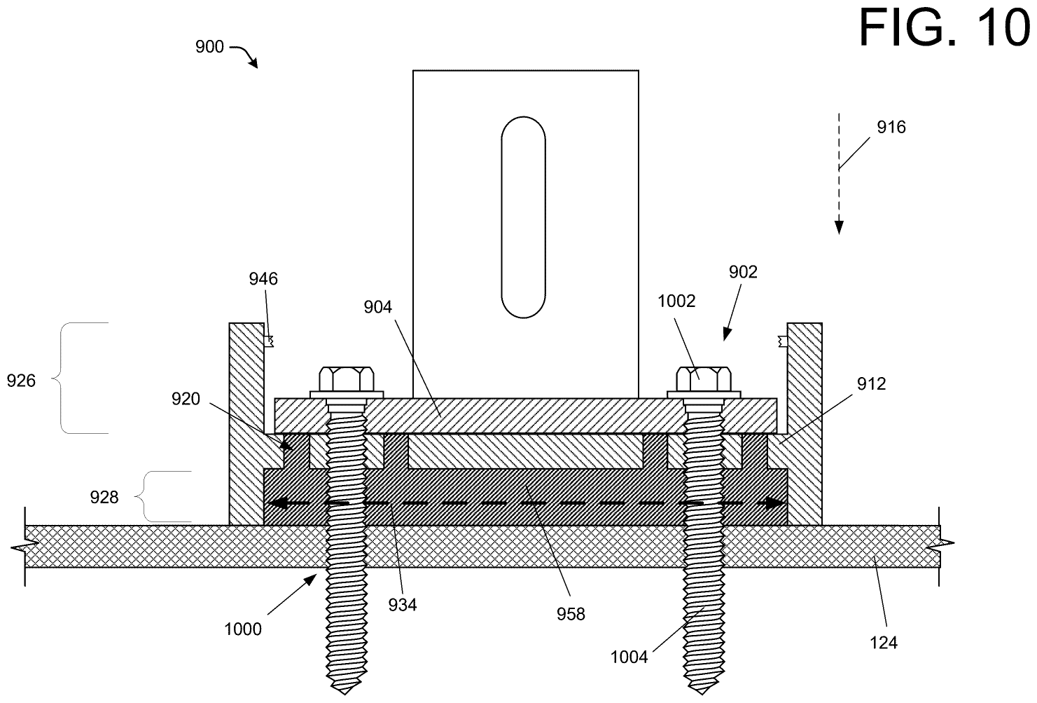

FIG. 10 illustrates a side cross-sectional view of the two-piece flashing-less attachment apparatus 900 (“apparatus 900”) of FIG. 9 fastened to the roof 124. In an embodiment, the fastener 902 may include a head 1002 and a pointed shaft 1004. The fastener 902 may be sized such that the head 1002 may engage with the piston 904 while the fastener travels in the first direction 916.

As the fastener 902 penetrates the top section 926 of the base 908, the fastener 902 may pierce the sealant packet 906 (not shown in FIG. 10, see FIG. 9), thereby creating a flow path for the sealant 958 out of the sealant packet 906 (not shown in FIG. 10, see FIG. 9).

In an embodiment, the movement of the fastener 902 in the first direction 916 may cause the piston 904 to induce stress on the one or more tabs 946 until the one or more tabs 946 fracture, thus allowing the piston 904 to travel in the first direction 916 until the piston 904 engages with the shelf 912. In an embodiment, the fastener 902 piercing the sealant packet 906 (not shown in FIG. 10, see FIG. 9) may allow the sealant packet 906 (not shown in FIG. 10, see FIG. 9) to be compressed by the piston 904 traveling in the first direction 916 toward the shelf 912.

In an embodiment, as the fastener 902 causes the piston 904 to travel in the first direction 916 toward the shelf 912, the piston 904 may compress the sealant packet 906 (not shown in FIG. 10, see FIG. 9) and force the sealant 958 to flow through the one or more apertures in the shelf 912 (e.g., one or more fastener apertures 918, one or more sealant flow apertures 920, etc.) to fill the cavity 934 of the bottom section 928 of the base 908. In an embodiment, when the sealant packet 906 (not shown in FIG. 10, see FIG. 9) is fully compressed (e.g., the piston 904 is engaged with the shelf 912), the cavity 934 of the bottom section 928 of the base 908 may be filled with sealant 958.

In an embodiment, the fastener 902 may be driven into the aperture 944 of the piston 904 and the fastener aperture 918 of the shelf 912 in the first direction 916 to penetrate the roof 124 and create a borehole 1000, thus piercing the top wall 952 and bottom wall 954 of the sealant packet 906 (not shown). In an embodiment, when the fastener 902 is fully inserted into the apparatus 900, the piston 904 may be engaged with the shelf 912 and the pointed shaft 1004 of the fastener 902 may extend through the cavity 934 of the bottom section 928 of the base 908 and the roof 124 via the borehole 1000. The sealant 958 may flow from the cavity 934 into the borehole 1000.

FIG. 11 illustrates a cross-sectional view of an attachment system 1100 that includes a roof mount 1102 with the flashing-less attachment apparatus 104 of FIG. 1 prepared for installation on the roof 124, according to an embodiment of this disclosure. Compared to the roof mount previously described herein (e.g., the roof mount 102), which may resemble a “T” shape, the roof mount 1102 may resemble an “L” shape. However, other shaped roof mounts (e.g., “Z” shaped, “C” shaped, “U” shaped, etc.) roof mounts may be used.

The roof mount 1102 may include an upper portion 1104 (e.g., mount portion, protrusion, stanchion, etc.) and a lower portion 1106 (e.g., base, etc.). In an embodiment, the upper portion 1104 may be configured to receive a mounting device (e.g., rail clamp, etc.). The upper portion 1104 may extend from the lower portion 1106 in the first direction 110.

In an embodiment, the lower portion 1106 may include a baseplate 1112, a first sidewall 1114 (e.g., front sidewall, etc.), a second sidewall 1116 (e.g., rear sidewall, etc.), and an aperture 1118. In an embodiment, the lower portion 1106 may include a cavity 1120 defined by the baseplate 1112, the first sidewall 1114, and the second sidewall 1116. The cavity 1120 may open in the second direction 120. In an embodiment, the cavity 1120 may open to the roof 124.

The roof mount 1102 may also be usable with the flashing-less attachment apparatuses described herein. For example, the roof mount 1102 may be usable with the two-piece flashing-less attachment apparatus 300 of FIG. 3, the one-piece flashing-less attachment apparatus 400 of FIG. 4, and/or the one-piece flashing-less attachment apparatus 500 of FIG. 5.

### CONCLUSION

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

As used herein, terms such as “attached,” “fastened,” “secured,” “disposed,” “connected,” and “coupled” (including variations thereof) are intended to be used interchangeably to refer to any form of interaction between components, whether directly or indirectly, permanently or temporarily, mechanically or otherwise. It will be understood that these terms are not intended to limit the nature of the interaction to a direct or immediate connection unless specifically stated, and may include indirect connections through one or more intermediary elements. Likewise, the terms “directly” and “indirectly” describe both physical contact between components and connections made through intermediate structures, mechanisms, or devices.

What is claimed is:

1. An apparatus comprising:
a mount to attach to a roof; and
a container disposed within the mount, the container including a top end and a bottom end, the container having:
a casing including:
a reservoir extending from the top end of the container to a bottom end of the reservoir, and
a conduit fluidly connected to the reservoir, the conduit extending from the bottom end of the reservoir to the bottom end of the container,
a plunger at least partially disposed within the reservoir, and
a sealant at least partially disposed within the reservoir.

2. The apparatus of claim 1 further, wherein:
the reservoir has a first width; and
the conduit has a second width less than the first width.

3. The apparatus of claim 1, wherein the casing includes:
a first sidewall extending from the top end of the container;
a shoulder extending from the first sidewall in a second direction toward a vertical centerline axis of the container; and
a second sidewall extending from the shoulder to the bottom end of the container.

4. The apparatus of claim 1, wherein the plunger includes:
a base extending a width of the reservoir; and
a sidewall extending from a top surface of the base, wherein the sidewall is engaged with the casing.

5. The apparatus of claim 1, wherein the plunger includes a sidewall engaged to an inside surface of the reservoir.

6. The apparatus of claim 1, further comprising a fastener to penetrate the container to secure the mount to the roof.

7. A container filled with sealant, the container comprising:
a casing including:
a reservoir having a first width,
a conduit having a second width less than the first width, and
a sealant partially disposed within the reservoir and the conduit; and
a plunger disposed within the reservoir, the plunger including a fastener.

8. The container of claim 7, wherein:
the reservoir includes a sidewall; and
the plunger includes a sidewall engaged with the sidewall of the reservoir.

9. The container of claim 7, wherein:
the fastener moves in a direction to penetrate a roof and create a borehole; and
the sealant flows from the conduit in the direction to seal the borehole.

10. The container of claim 7, wherein the casing and the plunger are a cast metal.

11. The container of claim 7, wherein a bottom end of the reservoir engages with an aperture disposed in a roof mount.

12. The container of claim 7, wherein a bottom end of the container engages with a roof.

13. An apparatus comprising:
a sealant;
a casing including:
an upper portion at least partially filled with the sealant, and
a lower portion fluidly connected to the upper portion and at least partially filled with the sealant, the lower portion extending from the upper portion in a direction;
a plunger disposed within the upper portion; and
a fastener to extend through the lower portion of the casing.

14. The apparatus of claim 13, wherein the fastener is integral with the plunger.

15. The apparatus of claim 13, wherein the lower portion of the casing includes:
a first portion having a second width, the first portion extending from the upper portion of the casing in the direction;
a second portion having a third width that is greater than the second width, the second portion extending from the first portion in the direction; and
a third portion having a fourth width that is greater than the third width, the third portion extending from the second portion in the direction.

16. The apparatus of claim 15, wherein the third portion engages with a top surface of a roof.

17. The apparatus of claim 13, wherein the fastener extends through the lower portion of the casing to penetrate a roof.

18. The apparatus of claim 13, wherein:
the fastener penetrates a roof to create a borehole; and
the lower portion of the casing directs a flow of sealant to the borehole.

19. The apparatus of claim 13, wherein the lower portion of the casing extends through an aperture of a roof mount.

20. The apparatus of claim 13, wherein the plunger includes a sidewall engaged to an inside surface of the upper portion of the casing.
